(19) United States
(12) Patent Application Publication
(10) Pub. No.: US 2020/0034781 A1
(43) Pub. Date: Jan. 30, 2020

(54) SYSTEM AND METHOD FOR COGNITIVE ADJACENCY PLANNING AND COGNITIVE PLANOGRAM DESIGN

(71) Applicant: International Business Machines Corporation, Armonk, NY (US)

(72) Inventors: Mohit Sewak, Lucknow (IN); Iman Choudhury, Bangalore (IN)

(21) Appl. No.: 16/047,162

(22) Filed: Jul. 27, 2018

(51) Int. Cl. G06Q 10/08; G06Q 10/06; G06N 99/00; G06Q 30/02

(52) U.S. Cl. CPC G06Q 10/087; G06Q 30/0201; G06N 99/005; G06Q 10/067

(57) ABSTRACT

A method, computer program product, and computing system are provided for defining a plurality of retail location-based sales data for a plurality of products. A plurality of association pairs may be defined from the plurality of products. A plurality of retail locations for the plurality of products may be determined based upon, at least in part, the plurality of retail location-based sales data for the plurality of products and the plurality of association pairs defined from the plurality of products. A planogram may be generated on a user interface, where the planogram may include placement of at least a portion of the plurality of products within a retail space based upon, at least in part, the plurality of retail locations for the plurality of products.

### BACKGROUND

Adjacency Planning is the function in retail, especially in physical/brick and mortar (B&M) stores, that determines where each product/stock keeping unit (SKU) needs to be placed to determine an optimal store layout. Traditionally a lot of human experience and heuristic goes into adjacency planning and finalizing store layout. Key performance indicators (KPIs) are not a factor of initial designing, and a post-hoc measurement or a result of the finalized design.

To optimize for a particular KPI, existing assortment planning, adjacency, and layout is changed iteratively as per expert/subject matter expert (SME)/local-authority experience and an objective function is re-measured. This manual/iterative process is a continuous and ongoing process with an unknown end/most-optimal state.

There are many drawbacks with conventional adjacency planning systems. Besides requiring tremendous manual knowledge and work, and being highly dependent upon SME support and knowledge, conventional adjacency planning systems do not have a steady state to which historic measurements could be corroborated to and hence does not produce any meaningful data for holistic optimization. Additionally, conventional adjacency planning systems lead to an ever-changing configuration which does not achieve its end goal except for small greedy optimizations.

Moreover, in many cases, when just one aspect of the design resulting from a conventional adjacency planning system needs to be altered e.g., an adjacency between two products, it may lead to changing the assortment as well, which could lead to reversal of the goals and in short run, leading to a volatile system.

Also, especially in case of fashion and other fast changing products, the assortment planning needs may be so frequent that such manual systems could not even attain a good local optimum, leave aside aiming to achieve global optima.

Another very important aspect, especially for fashion stores (e.g., B&M fashion stores) the concept of adjacency is not very scientific. Algorithms meant for general categories are currently applied to fashion subcategories planning as well. But as in fashion, even two similarly selling products might not be fashion synonymous, and placing them together (when they belong to different fashion concepts) may prove counterproductive. So far, there have not been any cognitive studies or artificial intelligence solutions involved in adjacency planning for fashion.

In fact, there have not been any cognitive/artificial intelligence/computer vision, or even advanced machine learning systems doing adjacency planning in a completely automated manner.

### BRIEF SUMMARY OF DISCLOSURE

In one example implementation, a computer-implemented method is executed on a computing device and may include but is not limited to defining a plurality of retail location-based sales data for a plurality of products. A plurality of association pairs may be defined from the plurality of products. A plurality of retail locations for the plurality of products may be determined based upon, at least in part, the plurality of retail location-based sales data for the plurality of products and the plurality of association pairs defined from the plurality of products. A planogram may be generated on a user interface, where the planogram may include placement of at least a portion of the plurality of products within a retail space based upon, at least in part, the plurality of retail locations for the plurality of products.

One or more of the following example features may be included. The plurality of products may include a plurality of fashion products and defining the plurality of association pairs from the plurality of fashion products may be based upon, at least in part, one or more of a plurality of fashion-ability scores representative of the plurality of fashion products and a visual similarity between the plurality of fashion products. Defining the plurality of association pairs from the plurality of products may include executing, via a machine learning system, one or more sequence mining algorithms on the plurality of retail location-based sales data to define one or more sequential relationships between a subset of the plurality of products purchased during a plurality of transactions. Determining the plurality of retail locations for the plurality of products may include receiving a selection of a marketing objective from a plurality of marketing objectives. Determining the plurality of retail locations for the plurality of products may include determining the plurality of retail locations for the plurality of products based upon, at least in part, the received marketing objective selection. The plurality of retail locations for the plurality of products may include relative positioning of the plurality of products with respect to one another based upon, at least in part, the plurality of retail location-based sales data for the plurality of products and the defined plurality of association pairs from the plurality of products. Generating the planogram on the user interface may include inserting a plurality of images representative of the at least a portion of the plurality of products into the planogram at the determined plurality of retail locations for the at least a portion of the plurality of products.

In another example implementation, a computer program product resides on a computer readable medium that has a plurality of instructions stored on it. When executed across one or more processors, the plurality of instructions cause at least a portion of the one or more processors to perform operations that may include but are not limited to defining a plurality of retail location-based sales data for a plurality of products. A plurality of association pairs from the plurality of products may be defined. A plurality of retail locations for the plurality of products may be determined based upon, at least in part, the plurality of retail location-based sales data for the plurality of products and the plurality of association pairs defined from the plurality of products. A planogram may be generated on a user interface, where the planogram may include placement of at least a portion of the plurality of products within a retail space based upon, at least in part, the plurality of retail locations for the plurality of products.

One or more of the following example features may be included. The plurality of products may include a plurality of fashion products and defining the plurality of association pairs from the plurality of fashion products may be based upon, at least in part, one or more of a plurality of fashion-ability scores representative of the plurality of fashion products and a visual similarity between the plurality of fashion products. Defining the plurality of association pairs from the plurality of products may include executing, via a machine learning system, one or more sequence mining algorithms on the plurality of retail location-based sales data to define one or more sequential relationships between a subset of the plurality of products purchased during a plurality of transactions. Determining the plurality of retail locations for the plurality of products may include receiving a selection of a marketing objective from a plurality of marketing objectives. Determining the plurality of retail locations for the plurality of products may include determining the plurality of retail locations for the plurality of products based upon, at least in part, the received marketing objective selection. The plurality of retail locations for the plurality of products may include relative positioning of the plurality of products with respect to one another based upon, at least in part, the plurality of retail location-based sales data for the plurality of products and the defined plurality of association pairs from the plurality of products. Generating the planogram on the user interface may include inserting a plurality of images representative of the at least a portion of the plurality of products into the planogram at the determined plurality of retail locations for the at least a portion of the plurality of products.

In another example implementation, a computing system comprising one or more processors and one or more memories, wherein the computing system is configured to perform operations that may include but are not limited to defining a plurality of retail location-based sales data for a plurality of products. A plurality of association pairs may be defined from the plurality of products. A plurality of retail locations for the plurality of products may be determined based upon, at least in part, the plurality of retail location-based sales data for the plurality of products and the plurality of association pairs defined from the plurality of products. A planogram may be generated on a user interface, where the planogram may include placement of at least a portion of the plurality of products within a retail space based upon, at least in part, the plurality of retail locations for the plurality of products.

One or more of the following example features may be included. The plurality of products may include a plurality of fashion products and defining the plurality of association pairs from the plurality of fashion products may be based upon, at least in part, one or more of a plurality of fashion-ability scores representative of the plurality of fashion products and a visual similarity between the plurality of fashion products. Defining the plurality of association pairs from the plurality of products may include executing, via a machine learning system, one or more sequence mining algorithms on the plurality of retail location-based sales data to define one or more sequential relationships between a subset of the plurality of products purchased during a plurality of transactions. Determining the plurality of retail locations for the plurality of products may include receiving a selection of a marketing objective from a plurality of marketing objectives. Determining the plurality of retail locations for the plurality of products may include determining the plurality of retail locations for the plurality of products based upon, at least in part, the received marketing objective selection. The plurality of retail locations for the plurality of products may include relative positioning of the plurality of products with respect to one another based upon, at least in part, the plurality of retail location-based sales data for the plurality of products and the defined plurality of association pairs from the plurality of products. Generating the planogram on the user interface may include inserting a plurality of images representative of the at least a portion of the plurality of products into the planogram at the determined plurality of retail locations for the at least a portion of the plurality of products.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE SEVERAL VIEWS OF THE DRAWINGS

FIG. 1 is an example diagrammatic view of a cognitive adjacency planning process coupled to a distributed computing network according to one or more example embodiments of the disclosure;

FIGS. 2-3 are example flowcharts of the cognitive adjacency planning process of FIG. 1 according to one or more example embodiments of the disclosure;

FIG. 4 is an example diagrammatic view of a the placement of a plurality of products in a retail space according to one or more example embodiments of the disclosure;

FIG. 5 is an example flowchart of the cognitive adjacency planning process according to one or more example embodiments of the disclosure;

FIG. 6 is an example diagrammatic view of the processing of images to generate one or more fashion-ability tensors and the generation of one or more fashion-ability scores representative of one or more fashion products according to one or more example embodiments of the disclosure;

FIG. 7-9 are example flowcharts of the cognitive adjacency planning process of FIG. 1 according to one or more example embodiments of the disclosure;

FIG. 10 is an example two-dimensional planogram generated by the cognitive adjacency planning process of FIG. 1 according to one or more example embodiments of the disclosure;

FIG. 11 is an example three-dimensional planogram generated by the cognitive adjacency planning process of FIG. 1 according to one or more example embodiments of the disclosure; and

FIG. 12 is an example diagrammatic view of a client electronic device of FIG. 1 according to one or more example embodiments of the disclosure.

Like reference symbols in the various drawings indicate like elements.

### DETAILED DESCRIPTION

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

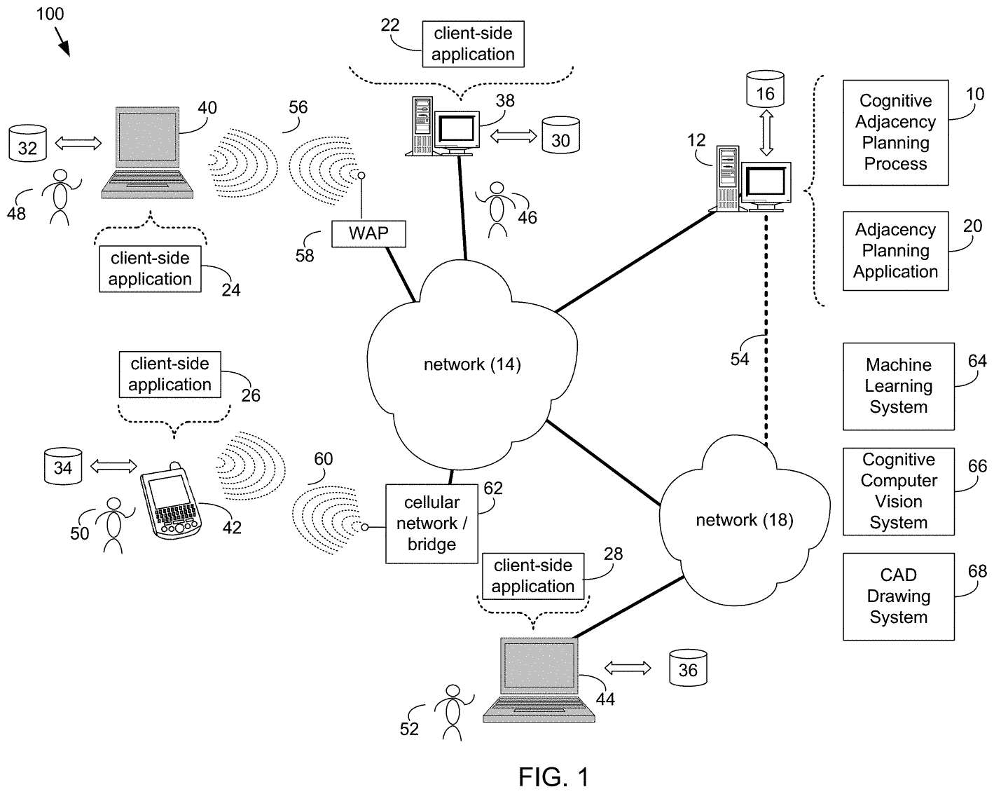

Referring now to FIG. 1, there is shown cognitive adjacency planning process 10 that may reside on and may be executed by a computing device 12, which may be connected to a network (e.g., network 14) (e.g., the interne or a local area network). Examples of computing device 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computing device 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, a cognitive adjacency planning process, such as cognitive adjacency planning process 10 of FIG. 1, may define, on a computing device, a plurality of retail location-based sales data for a plurality of products. A plurality of association pairs from the plurality of products may be defined. A plurality of retail locations for the plurality of products may be determined based upon, at least in part, the plurality of retail location-based sales data for the plurality of products and the plurality of association pairs defined from the plurality of products. A planogram may be generated on a user interface, where the planogram may include placement of at least a portion of the plurality of products within a retail space based upon, at least in part, the plurality of retail locations for the plurality of products.

The instruction sets and subroutines of cognitive adjacency planning process 10, which may be stored on storage device 16 coupled to computing device 12, may be executed by one or more processors (not shown) and one or more memory architectures (not shown) included within computing device 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Cognitive adjacency planning process 10 may be a stand-alone application that interfaces with an applet/application that is accessed via client applications 22, 24, 26, 28. In some embodiments, cognitive adjacency planning process 10 may be, in whole or in part, distributed in a cloud computing topology. In this way, computing device 12 and storage device 16 may refer to multiple devices, which may also be distributed throughout network 14 and/or network 18.

Computing device 12 may execute an adjacency planning application (e.g., adjacency planning application 20), examples of which may include, but are not limited to, applications, portals, programs, and/or websites that facilitate the adjacency planning and/or the placement of products within a retail space. Cognitive adjacency planning process 10 and/or adjacency planning application 20 may be accessed via client applications 22, 24, 26, 28. Cognitive adjacency planning process 10 may be a stand-alone application, or may be an applet/application/script/extension that may interact with and/or be executed within adjacency planning application 20, a component of adjacency planning application 20, and/or one or more of client applications 22, 24, 26, 28. adjacency planning application 20 may be a stand-alone application, or may be an applet/application /script/extension that may interact with and/or be executed within cognitive adjacency planning process 10, a component of cognitive adjacency planning process 10, and/or one or more of client applications 22, 24, 26, 28. One or more of client applications 22, 24, 26, 28 may be a stand-alone application, or may be an applet/application/script/extension that may interact with and/or be executed within and/or be a component of cognitive adjacency planning process 10 and/or adjacency planning application 20. Examples of client applications 22, 24, 26, 28 may include, but are not limited to, applications that receive queries to search for content from one or more databases, servers, cloud storage servers, etc., a textual and/or a graphical user interface, a standard web browser, a customized web browser, a plugin, an Application Programming Interface (API), or a custom application. The instruction sets and subroutines of client applications 22, 24, 26, 28 which may be stored on storage devices 30, 32, 34, 36 coupled to client electronic devices 38, 40, 42, 44 may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computing device 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Microsoft® Windows®; Mac® OS X®; Red Hat® Linux®, Windows® Mobile, Chrome OS, Blackberry OS, Fire OS, or a custom operating system.

One or more of client applications 22, 24, 26, 28 may be configured to effectuate some or all of the functionality of cognitive adjacency planning process 10 (and vice versa). Accordingly, cognitive adjacency planning process 10 may be a purely server-side application, a purely client-side application, or a hybrid server-side/client-side application that is cooperatively executed by one or more of client applications 22, 24, 26, 28 and/or cognitive adjacency planning process 10.

One or more of client applications 22, 24, 26, 28 may be configured to effectuate some or all of the functionality of adjacency planning application 20 (and vice versa). Accordingly, adjacency planning application 20 may be a purely server-side application, a purely client-side application, or a hybrid server-side/client-side application that is cooperatively executed by one or more of client applications 22, 24, 26, 28 and/or adjacency planning application 20. As one or more of client applications 22, 24, 26, 28 cognitive adjacency planning process 10, and adjacency planning application 20, taken singly or in any combination, may effectuate some or all of the same functionality, any description of effectuating such functionality via one or more of client applications 22, 24, 26, 28 cognitive adjacency planning process 10, adjacency planning application 20, or combination thereof, and any described interaction(s) between one or more of client applications 22, 24, 26, 28 cognitive adjacency planning process 10, adjacency planning application 20, or combination thereof to effectuate such functionality, should be taken as an example only and not to limit the scope of the disclosure.

Users 46, 48, 50, 52 may access computing device 12 and cognitive adjacency planning process 10 (e.g., using one or more of client electronic devices 38, 40, 42, 44) directly or indirectly through network 14 or through secondary network 18. Further, computing device 12 may be connected to network 14 through secondary network 18, as illustrated with phantom link line 54. Cognitive adjacency planning process 10 may include one or more user interfaces, such as browsers and textual or graphical user interfaces, through which users 46, 48, 50, 52 may access cognitive adjacency planning process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 800.11a, 800.11b, 800.11g, Wi-Fi®, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 800.11x specifications may use Ethernet protocol and carrier sense multiple access with collision avoidance (i.e., CSMA/CA) for path sharing. The various 800.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

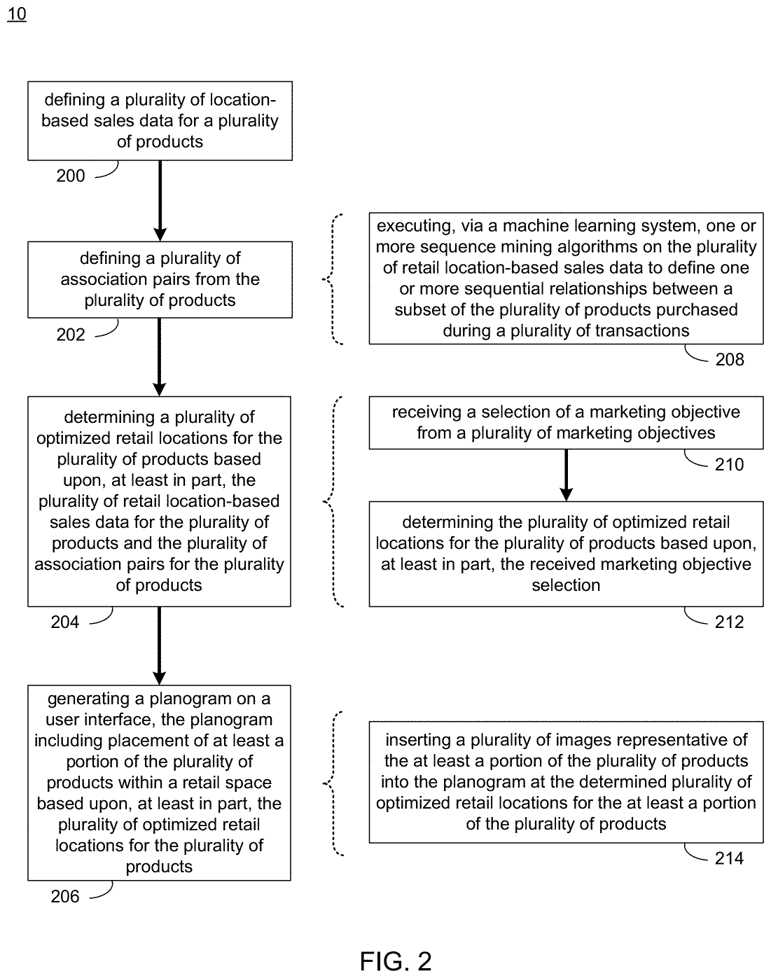

As discussed above and referring also at least to FIGS. 2-12, cognitive adjacency planning process 10 may define 200, on a computing device, a plurality of retail location-based sales data for a plurality of products. A plurality of association pairs may be defined 202 from the plurality of products. A plurality of retail locations for the plurality of products may be determined 204 based upon, at least in part, the plurality of retail location-based sales data for the plurality of products and the plurality of association pairs defined from the plurality of products. A planogram may be generated 206 on a user interface, where the planogram may include placement of at least a portion of the plurality of products within a retail space based upon, at least in part, the plurality of retail locations for the plurality of products.

In some embodiments consistent with the present disclosure, systems and methods may be provided for cognitive adjacency planning and cognitive planogram design. Specifically, cognitive adjacency planning process 10 may provide adjacency planning via an automatically generated planogram based upon, at least in part, a plurality of retail location-based sales data and computer vision capacities configured to define association pairs or adjacency relationships between products. For example, certain products may have a retail relationship such that a certain adjacency or relative proximity of a first product to a second product affects a consumer's decision to purchase the first and/or second product(s). Consider an example where a consumer enters a retail space to purchase a first product (e.g., bread). If a second product (e.g., butter) is located within a defined adjacency or relative proximity to the first product (e.g., bread), the consumer may be more likely to purchase the second product (e.g., butter) when the consumer sees and purchases the first product (e.g., bread).

In contrast, consider an example involving fashion products, where even two similarly selling fashion products might not be “fashion synonymous”, and placing them together (when they belong to different fashion concepts or categories) may prove counterproductive. Additionally, fashion products may be particularly time-variant because a consumer's fashion taste may change over time. For example, consumers' interest in a particular fashion product may change in response to e.g., social trends, fashion trends, demographic changes, socio-economic changes, etc. When entering a retail space (e.g., a brick and mortar store) with one or more fashion products, a user may view various fashion products. Suppose that a first fashion product (e.g., an expensive, high quality coat) is adjacent to a second fashion product (e.g., an inexpensive, lower quality coat). While both fashion products may be coats and may even sell at similar rates when separate (e.g., not adjacent), consumers may, for example, perceive the first fashion product (e.g., the expensive, high quality coat) and incorrectly determine that the second fashion product (e.g., the inexpensive, lower quality coat) as too expensive for the consumer's taste and/or budget because of the second fashion product's adjacency to the first fashion product. In another example, a consumer may perceive the second fashion product (e.g., the inexpensive, lower quality coat) and incorrectly determine that the first fashion product (e.g., the expensive, high quality coat) as presumably a lower-quality fashion product because of the first fashion product's adjacency to the second fashion product. It will be appreciated that various situations may occur where the adjacency and/or separation of products, especially fashion products, may cause challenges and/or opportunities for the purchase of products in retail spaces (e.g., B&M stores).

To automatically provide adjacency planning and as will be discussed in greater detail below, implementations of cognitive adjacency planning process 10 may cognitively determine a plurality of retail locations for a plurality of products based upon, at least in part, a plurality of retail location-based sales data for the plurality of products and a plurality of association pairs defined from the plurality of products. From these retail locations, implementations of cognitive adjacency planning process 10 may generate a planogram on a user interface, where the planogram includes placement of at least a portion of the plurality of products within a retail space (e.g., a B&M store). As discussed above, implementations of cognitive adjacency planning process 10 may overcome challenges and limitations found in conventional adjacency planning systems that require tremendous manual knowledge and work, and are highly dependent upon SME support and knowledge. Additionally, implementations of cognitive adjacency planning process 10 may provide dynamic yet measurable adjacency planning and planograms to reflect the highly subjective and time-variant nature of fashion products.

As will be discussed in greater detail below and in some embodiments, cognitive adjacency planning process 10 may determine optimized retail locations (e.g., placement of products within a retail space) based upon, at least in part, cognitive and visual analytics associated with visual perceptions of products and the perceptions of products based upon, at least in part, their adjacency or proximity to other products.

As generally discussed above with reference to FIGS. 2-4, cognitive adjacency planning process 10 may define 200, on a computing device, a plurality of location-based sales data for a plurality of products. Products may generally include any object that may be sold in a retail space. In some implementations, the plurality of products may include a plurality of fashion products. Fashion products may generally include, but are not limited to, on or more of articles of clothing (e.g., shirts, pants, dresses, shorts, jackets, etc.), clothing accessories (e.g., shoes, socks, belts, hats, scarfs, etc.), jewelry (e.g., necklaces, earrings, bracelets, watches, pins, etc.), and the like. While fashion products have been described, it will be appreciated that location-based sales data may be defined 200 for various types of products within the scope of the present disclosure.

As will be discussed in greater detail below, location-based sales data may generally include sales information (e.g., from a plurality of transactions involving the purchase of the product) with associated location or position data for the product in the retail space from which it is purchased. For example, suppose a plurality of products are placed at various locations within a retail space (e.g., B&M store). As the products are purchased by one or more consumers, the location of each of the products within the retail space may be linked or associated with the transaction information. In some implementations, a sales record system may be configured to record sales data from transactions. In some implementations, a sales record system and/or a separate product inventory system may record the location of each product within a retail space.

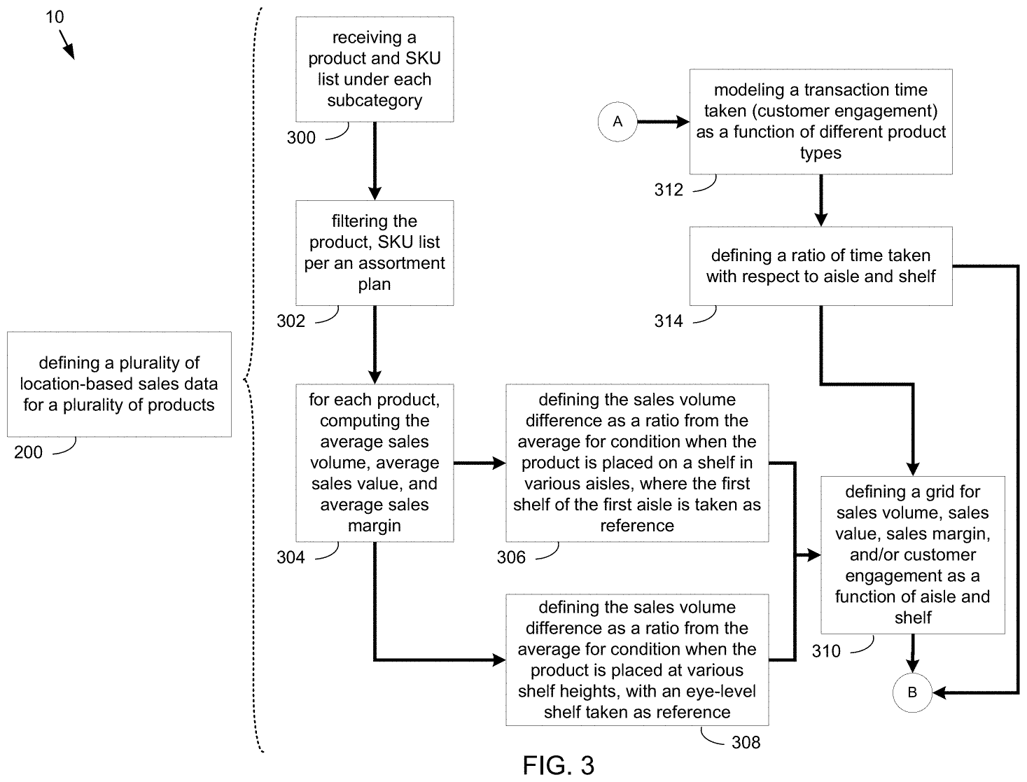

Referring also to FIG. 3, defining 200 the plurality of location-based sales data for a plurality of products may include receiving 300 a selection of a plurality of products and/or a stock keeping unit (SKU) list. In some implementations and as will be discussed in greater detail below, the plurality of products may be organized and/or separated into a plurality of categories or subcategories depending upon, at least in part, a product type. In some implementations, receiving 300 the selection of a plurality of products and the stock keeping unit (SKU) list may include receiving a selection of a plurality of products for a specific subcategory of products. For example, a user of an adjacency planning application (e.g., adjacency planning application 20) may be presented with a user interface for selecting or otherwise providing a selection of products to include in an adjacency plan and/or a planogram for a retail space including the plurality of products. In some implementations, a user may specify products by defining or populating a list of SKUs.

In some implementations, defining 200 the plurality of location-based sales data for the plurality of products may include filtering 302 at least a subset of the plurality of products and/or SKUs per an assortment plan. An assortment plan may generally include the automated or manual selection and planning of product retail. As such, an assortment plan may define which products from a plurality of products to include in a cognitive adjacency plan and/or cognitive planogram design. In some implementations, filtering 302 the at least a subset of the plurality of products per an assortment plan may be optional and may be bypassed.

In some implementations, defining 200 the plurality of location-based sales data for the plurality of products may include computing 304, for each product, an average sales volume, an average sales value, and/or an average sales margin. An average sales volume may generally include the average quantity or number of products sold in a particular period of time. The period of time may be any period of time during which a product is sold (e.g., a week, a month, a year, etc.). An average sales value may generally include the average price or value at which a particular product is sold across channels or markets. An average sales margin may generally include a percentage of profit associated with the sale of product from the sale price.

In some implementations and in response to computing 304 one or more of the average sales volume, average sales value, and average sales margin for each product, cognitive adjacency planning process 10 may define 306 a sales volume difference as a ratio from the average for various product locations throughout a retail space. Specifically, a sales volume difference as a ratio from the average sales volume for a product placement on the same shelf in various aisles, where the first aisle near e.g., an entrance is taken as the reference.

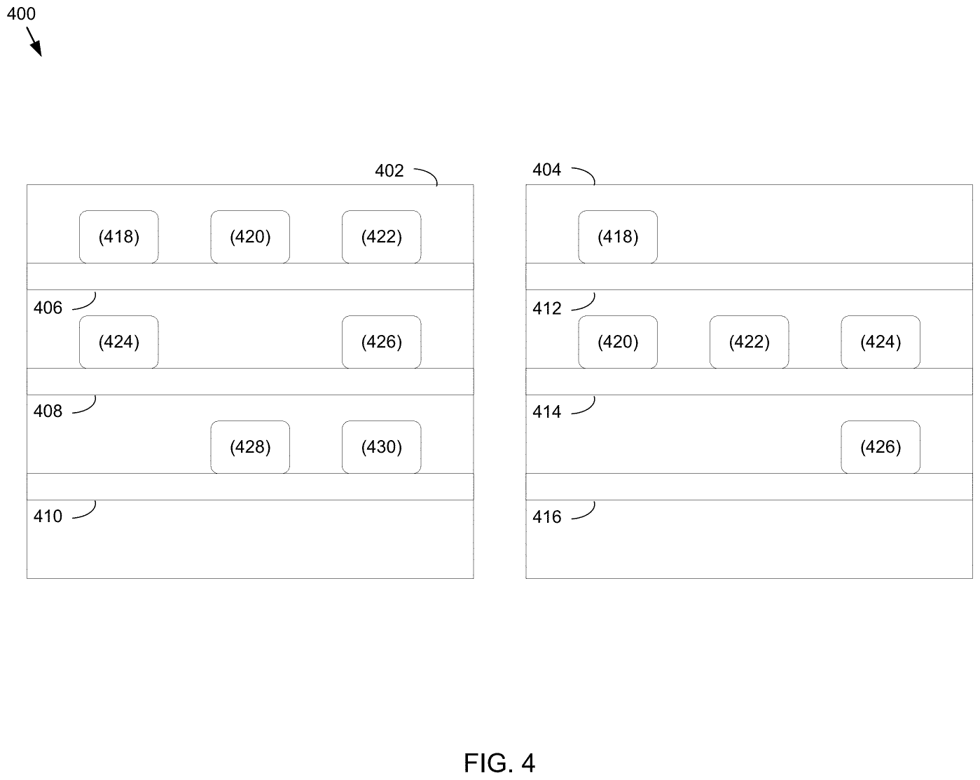

For example, and referring also to FIG. 4, suppose a retail space (e.g., retail space 400) includes e.g., two aisles (e.g., aisles 402, 404) with e.g., three shelves each (e.g., shelves 406, 408, 410, 412, 414, 416). Further suppose that a plurality of products (e.g., products 418, 420, 422, 424, 426, 428, 430) are positioned upon the various shelves (e.g., shelves 406, 408, 410, 412, 414, 416) of various aisles (e.g., aisles 402, 404). While shelves and aisles have been discussed, it will be appreciated that other configurations for presenting products for sale may be utilized. For example, linear and/or circular clothing racks may be utilized to hold e.g., hangars for clothing products. Display cases and endcaps may be used to present products to consumers in various retail space configurations. For food products, refrigeration units may be deployed in a retail space to maintain appropriate temperatures. As such, it will be appreciated that various product placement devices and configurations are possible within the scope of the present disclosure.

In some implementations, the amount of sales of a product may change as a function of the product location. For example, suppose aisle 402 is in a first retail space and aisle 404 is in a second retail space. Sales of product 420 may be different for each retail space. For example, positioning of product 420 in the e.g., second position on a e.g., third shelf (e.g., shelf 406) of the first aisle may impact the sales of the product relative to the sales of product 420 when the product is positioned in a first position of a second shelf (e.g., shelf 414). Cognitive adjacency planning process 10 may define 306 a sales volume difference as a ratio from the average sales volume for a product placement on a shelf in various aisles, where the first aisle is taken as the reference. For example, sales volume for a product may increase or decrease based upon, at least in part, the positioning of the product in various aisles of a retail space. In some implementations, cognitive adjacency planning process 10 may define 306 a sales value different and/or sales margin difference as a ratio from the average sales value and/or average sales margin for a product placed on a shelf in various aisles.

In some implementations, cognitive adjacency planning process 10 may define 308 the sales volume difference as a ratio from the average for various shelf heights of products, with an eye-level shelf taken as reference. Returning to the above example, suppose the sales of product 420 changes based upon, at least in part, the shelf of an aisle on which it is placed. Because the sales changes as a function of the shelf placement, cognitive adjacency planning process 10 may define 308 the sales volume difference as a ratio from the average for various shelf heights of products.

In some implementations, cognitive adjacency planning process 10 may define 310 a grid for one or more of sales volume, sales value, sales margin, and/or customer engagement as a function of aisle and shelf. In some implementations, cognitive adjacency planning process 10 may combine the defined sales volume, sales value, and/or sales margin difference ratios as a function of the product placement per aisle and the defined sales volume, sales value, and/or sales margin difference ratios as a function of the product placement per shelf to generate a grid or table of sales volume, sales value, and/or sales margin as a function of the aisle and shelf upon which a product is placed.

In some implementations, cognitive adjacency planning process 10 may model 312 a transaction time (e.g., customer engagement) as a function of different product types. For example and in some implementations, the placement of certain products in a retail space may increase or decrease the amount of time a consumer spends interacting with products. For example, certain products may entice consumers to spend more time looking at other products and may even result in additional products being purchased based upon, at least in part, the placement of the products in the retail space. In some implementations, certain products may repel or cause consumers to become disinterested in products based upon, at least in part, the placement of the products in the retail space. Modeling 312 the transaction time may include, and as will be discussed in greater detail below, receiving a sequence of product associations. For example, interaction with a sequence of products may impact the overall customer engagement or transaction time in a retail space. Modeling 312 may include using linear algebra functions or algorithms and/or supervised learning to determine the transaction time as a function of different product types.

In some implementations, cognitive adjacency planning process 10 may define 314 a ratio of time taken with respect to a product location. For example and as discussed above, customer engagement may be impacted by the consumer's perception and interaction with products in each portion of a retail space. For example, suppose a customer has come to a retail space to purchase a new shirt. The customer may view several shirts (e.g., products 418, 420, 422, 424, 426, 428, 430) in a first aisle (e.g., aisle 402) of a retail space. For example, suppose a particular shirt (e.g., product 426) is very popular and/or in style. In this example, product 426 may be placed on a second shelf (e.g., shelf 408). As such, a customer may spend more time viewing the selection of shirts based upon, at least in part, the location of the popular shirt (e.g., product 426).

In some implementations, cognitive adjacency planning process 10 may define 310 a grid for customer engagement as a function of the placement of the product in a retail space. For example and as discussed above, cognitive adjacency planning process 10 may define 310 a grid for customer engagement as a function of the aisle and shelf of the placement of products in the retail space.

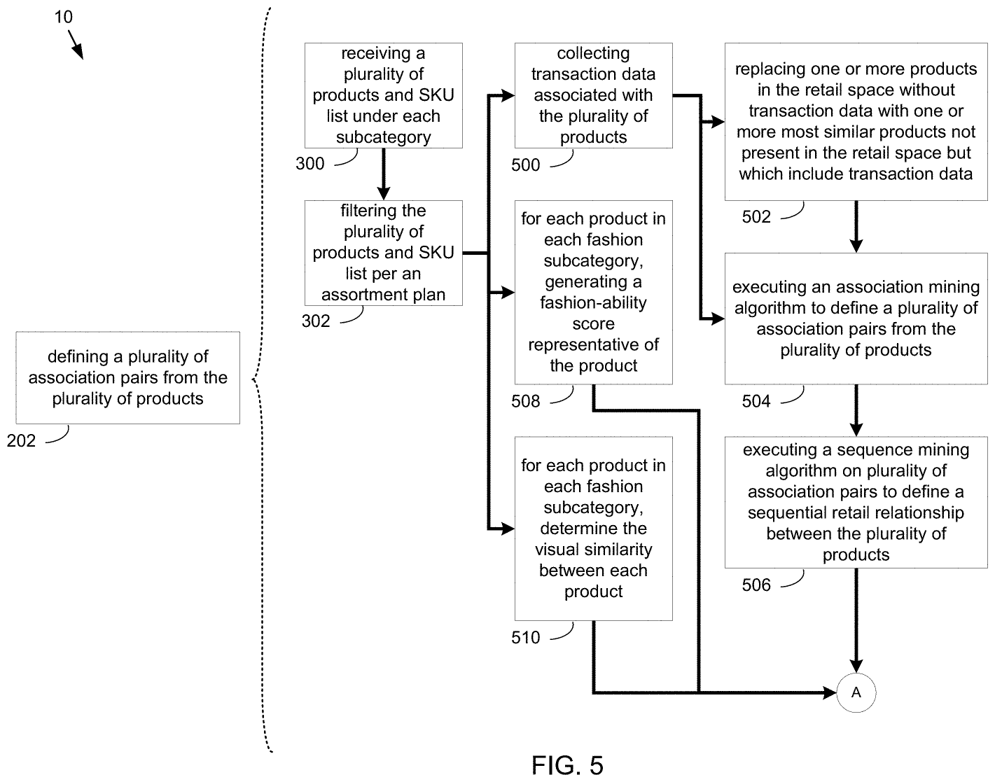

In some implementations, cognitive adjacency planning process 10 may define 202 a plurality of association pairs from the plurality of products. An association pair may generally include a pair of related products in terms of use, purchase, interest, similarity, etc. For example and referring also to FIG. 5, cognitive adjacency planning process 10 may receive 300 a selection of a plurality of products and a stock keeping unit (SKU) list and/or filter 302 at least a subset of the plurality of products and/or SKUs per an assortment plan. In some implementations, cognitive adjacency planning process 10 may collect 500 transaction data associated with the plurality of products. For example, cognitive adjacency planning process 10 may collect 500 transaction data and market basket data for existing products in a retail space and/or from other similar retail spaces of eCommerce applications or portals. In some implementations, cognitive adjacency planning process 10 may replace 502 one or more products in the retail space without transaction data with one or more most similar products not present in the retail space but which include transaction data. For example, certain products available or configured to be available for retail in a retail space may not include transaction data. Cognitive adjacency planning process 10 may utilize cognitive visual similarity algorithms and/or multi-contextual similarity algorithms (e.g., via cognitive computer vision system 66) to replace 502 the one or more products in the retail space without transaction data with one or more most similar products not present in the retail space but which include transaction data. For example and as will be discussed in greater detail below, visual similarity between a product in the retail space but without transaction data and a product not in the retail space but with transaction data may be determined.

In some implementations and with transaction data for the plurality of products, cognitive adjacency planning process 10 may execute 504 an association mining algorithm to define a plurality of association pairs from the plurality of products. For example, an association mining algorithm may be configured to find frequent patterns, correlations, associations, or causal structures from data sets. In some implementations, association mining may be executed 504 on the collected transaction data to determine associations between products purchased in the same transaction. From these associations, cognitive adjacency planning process 10 may define 202 a plurality of associations between the plurality of products. For example, suppose the transactional data includes frequent transactions including three products (e.g., products 418, 420, 422). In some implementations, cognitive adjacency planning process 10 may define an association pair between products 418, 420, and 422. In some implementations, cognitive adjacency planning process 10 may define an association pair between products 418 and 420, an association pair between products 420 and 422, and an association pair between products 418 and 422. In some implementations, each association pair may include a weight or confidence metric indicative of the confidence of the association or relationship between the products.

In some implementations, cognitive adjacency planning process 10 may execute 506 a sequence mining algorithm on plurality of association pairs to define a sequential retail relationship between the plurality of products. For example, sequence mining may include finding statistically relevant patterns between data examples where the values are delivered in a sequence. In some implementations, the purchase of products in a retail space may be influenced based upon, at least in part, the sequence of purchases in a retail space. In some implementations, cognitive adjacency planning process 10 may define sequential relationships between a plurality of products based upon, at least in part, the transaction data. As discussed above relative to FIG. 3 and in some implementations, cognitive adjacency planning process 10 may model 312 a transaction time taken (customer engagement) as a function of different product types based upon, at least in part, a sequential relationship between the plurality of products.

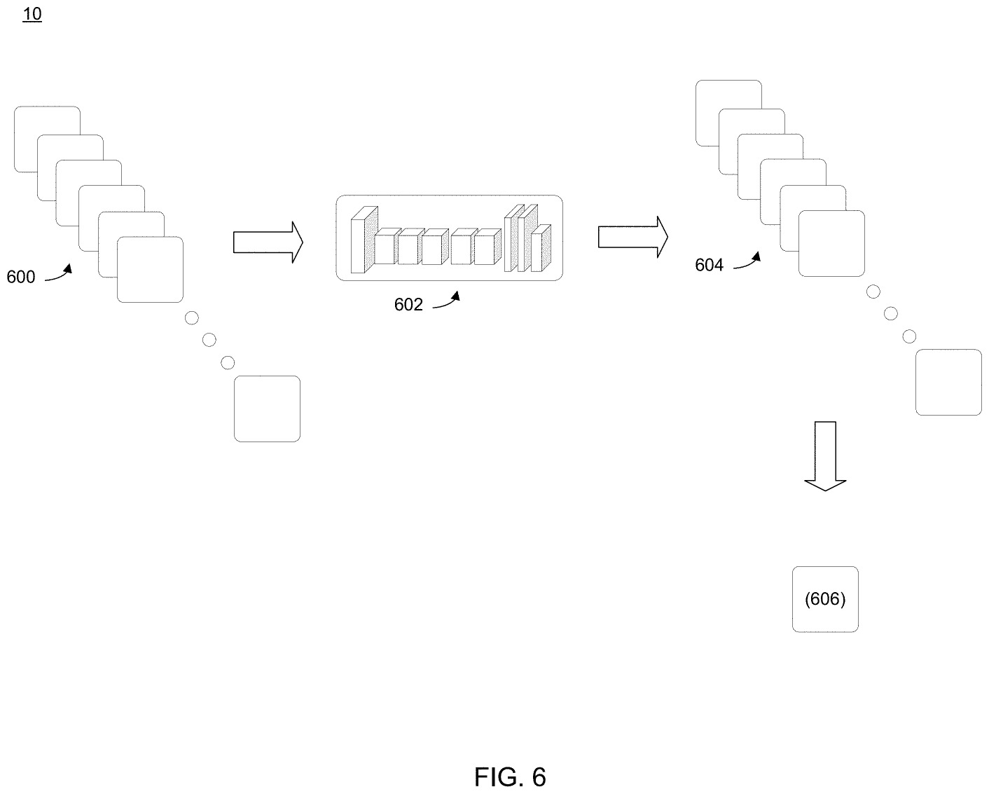

In some implementations, cognitive adjacency planning process 10 may generate 508 a fashion-ability score representative of the plurality of fashion products. As discussed above and in some implementations, the plurality of products may include a plurality of fashion products. A fashion-ability score may generally include a numerical representation of a fashion product defined for one or more attributes associated with the one or more fashion products. These fashion-ability scores may be generated by processing the image(s) of one or more fashion products using a neural network and by training the neural network with one or more attributes associated with the fashion product. For example and referring also to FIG. 6, cognitive adjacency planning process 10 may receive one or more images of one or more fashion products (e.g., images 600). The one or more images (e.g., images 600) may be digital representations displayed on a user interface and/or may be physical photographs or reproduction of photographs. In some embodiments, cognitive adjacency planning process 10 may receive the plurality of images (e.g., images 600) via a camera system. Additionally, the one or more images of the one or more fashion products (e.g., images 700) may be received from a computing device (e.g., client electronic devices 38, 40, 42, 44 (and/or computing device 12)). It will be appreciated that the one or more images of the one or more fashion products (e.g., images 600) may be received in various ways within the scope of the present disclosure. In some embodiments, the one or more images (e.g., images 600) may be stored in a repository or other database for processing.

In some embodiments, cognitive adjacency planning process 10 may receive metadata associated with the one or more images. For example, for each image, cognitive adjacency planning process 10 may receive metadata corresponding to different characteristics or attributes of the one or more images of the one or more fashion products. In some embodiments, metadata may be visual or non-visual (e.g., tags, features extracted from description, brand, color, price, price history, discounts, etc.) Examples of the metadata associated with the one or more images may include, but is not limited to, categories of the one or more fashion products, materials of the one or more fashion products, patterns of the one or more fashion products, age groups associated with the one or more fashion products, gender associated with the one or more fashion products, price associated with the one or more fashion products, the trendiness of the one or more fashion products, the highest year trending of the one or more fashion products, the number of social media likes associated with the one or more fashion products, survey responses associated with one or more fashion products, etc. As will be discussed in greater detail below, the metadata associated with the one or more images may be used as a training classification or attribute when processing the one or more images by cognitive adjacency planning process 10. In some embodiments, the metadata may be categorical (e.g., movies or television programs in which this fashion product appeared), continuous (e.g., price of fashion product), and/or a combination of categorical and continuous (e.g., price perception by age).

In some embodiments, cognitive adjacency planning process 10 may define one or more categories associated with the one or more fashion products based upon, at least in part, the one or more images (e.g., images 600) and the metadata associated with the one or more images. For example, cognitive adjacency planning process 10 may define categories associated with the one or more fashion products to include categories such as outerwear, innerwear, coats, jackets, hats, scarves, dresses, shoes, socks, shirts, blouses, pants, skirts, ties, suits, etc. based upon the one or more images and the metadata associated with the one or more images. While several possible categories for the one or more fashion products have been provided, it will be appreciated that other categories are possible within the scope of the present disclosure. In some embodiments, cognitive adjacency planning process 10 may define one or more sub-categories for the one or more categories. For example, cognitive adjacency planning process 10 may define sub-categories associated with the category the “shirts” category to include men's shirts, women's shirts, boy's shirts, girl's shirts, t-shirts, novelty t-shirts, long-sleeve shirts, sleeveless shirts, workout shirts, swimming shirts, etc. While several possible sub-categories for the “shirts” category have been provided, it will be appreciated that other sub-categories are possible within the scope of the present disclosure for various categories defined for the one or more fashion products.

In some embodiments, cognitive adjacency planning process 10 may process the one or more of images of the one or more fashion products (e.g., images 600) to generate one or more fashion-ability tensors. In some embodiments, cognitive adjacency planning process 10 may process the one or more images (e.g., images 600) using a neural network. For example, cognitive adjacency planning process 10 may receive the one or more images (e.g., images 600) and may process the one or more images via a neural network (e.g., neural network 602). A neural network may generally include a computing system that “learns” to do tasks by processing examples. In some embodiments, a neural network is able to differentiate images from one another by analyzing a plurality of example images across one or more attributes. From this “training” with pre-identified images, a neural network (e.g., neural network 602) is able to generally identify a similar image and/or differentiate an image against other images for a given attribute or dimension. For example and as discussed above, metadata associated with the one or more images may be used as attributes or dimensions to train the one or more images on the neural network (e.g., neural network 602) of cognitive adjacency planning process 10. Additional details regarding neural networks are described, for example, in Sewak, M., Md, Karim, R., & Pujaru, P. (2018). Practical Convolutional Neural Networks. (pp. 91-113). Birmingham, UK: Packt Publishing., which is incorporated herein by reference.

In some embodiments, processing the one or more images of the one or more fashion products may include selecting one or more images to process via the neural network (e.g., neural network 602). For example, cognitive adjacency planning process 10 may receive some training data (e.g., one or more images of the one or more fashion products) and test and validation data (e.g., one or more examples images of one or more fashion products). In some embodiments, the selection of which images to process may be automatic and/or may be defined manually by a user (e.g., using a user interface). In some embodiments, the selection of training data may be based upon, at least in part, the one or more categories and/or one or more sub-categories defined for the one or more fashion products shown in the one or more images. For example, certain models or types of neural network (e.g., neural network 602) may perform better (e.g., more discrete classification of images) for certain categories and/or sub-categories of fashion products. In experiments conducted by the Applicant, the model architecture or type of neural network (e.g., neural network 602) that may best define fashion-ability scores for different categories and/or different sub-categories of fashion products may differ and hence one-size or one neural network model may not fit all categories and/or sub-categories of fashion products. In some embodiments, cognitive adjacency planning process 10 may provide the flexibility to cognitively identify and select the right artificial-intelligence methodology/topology/neural network (e.g., neural network 602) to process the one or more images of a particular category and/or sub-category of fashion product to generate the one or more fashion-ability scores.

In some embodiments, cognitive adjacency planning process 10 may include a repository or other data structure including one or more model architectures or types of neural networks (e.g., neural network 602) to process the one or more images of the one or more fashion products (e.g., images 600). Examples of models or types of neural networks may generally include VGG16 Model Architecture, GoogLeNet, LeNet, ResNet, Inception, Xception, etc. It will be appreciated that various models or types of neural networks (e.g., neural network 602) may be used within the scope of the present disclosure. For example, any neural network or other model architecture configured for deep learning may be used within the scope of the present disclosure to process the one or more images of the one or more fashion products.

In some embodiments, cognitive adjacency planning process 10 may select a model architecture or type of neural network (e.g., neural network 602) based upon, at least in part, the one or more categories and/or sub-categories of the one or more images of the one or more fashion products (e.g., images 600). In some embodiments, a model may be trained for each category and/or each sub-category. In some embodiments, cognitive adjacency planning process 10 may select one or more attributes to train the neural network (e.g., neural network 602) with. For example, a neural network (e.g., neural network 602) may be trained to differentiate one or more images from a particular category or sub-category across the selected attribute. An attribute selected for training a neural network may also be referred to as a dimension. Cognitive adjacency planning process 10 may train the selected model or type of neural network (e.g., neural network 602) with the one or more images of the one or more fashion products across the selected attribute. In some embodiments, cognitive adjacency planning process 10 may store the trained neural network in a repository or other data structure.

In some embodiments, cognitive adjacency planning process 10 may generate one or more fashion-ability tensors (e.g., fashion-ability tensors 604) representative of the one or more fashion products for various models or types of neural networks. For example, cognitive adjacency planning process 10 may retrieve each trained neural network and score each of the one or more images against every attribute or dimension that the neural network is trained for. In some embodiments, the scoring of each image may generate one or more scored vectors, where each vector corresponds to a particular attribute used to train the neural network. Cognitive adjacency planning process 10 may join each of the scored vectors for a particular fashion product or image of the fashion product to form a multi-dimensional vector or fashion-ability tensor (e.g., fashion-ability tensors 604) corresponding to the visual representation of the fashion product.

In some embodiments, cognitive adjacency planning process 10 may generate the one or more fashion-ability scores representative of the one or more fashion products by selecting an attribute or dimension for generating a fashion-ability score and retrieving the vector trained for the selected attribute from the fashion-ability tensor for the fashion product (e.g., fashion-ability tensors 604). In response to retrieving the vector trained for the selected attribute from the fashion-ability tensor for the fashion product (e.g., fashion-ability tensors 604), cognitive adjacency planning process 10 may produce a fashion-ability score (e.g., fashion-ability score 606) that represents a fashion product for the selected dimension. For example, cognitive adjacency planning process 10 may select one or more attributes to define a fashion-ability score (e.g., fashion-ability score 606) for (e.g., trendiness of a fashion product for a given age-group). Cognitive adjacency planning process 10 may retrieve the vector from the fashion-ability tensor (e.g., fashion-ability tensors 604) for e.g., trendiness for a given age group to generate the one or more fashion-ability scores (e.g., fashion-ability score 606) representative of the one or more fashion products for the selected attribute of e.g., trendiness of a fashion product for a given age-group. In some embodiments, the generated fashion-ability score for the one or more fashion products (e.g., fashion-ability score 606) may represent the e.g., trendiness of a fashion product for a given age-group as a score. For example and in some embodiments, a higher fashion-ability score (e.g., fashion-ability score 606) may indicate that a particular fashion product is e.g., more trendy among a given age-group and a lower fashion-ability score (e.g., fashion-ability score 606) may indicate that a particular fashion product is e.g., less trendy among the given age-group. While the example attribute of “trendiness of a fashion product for a given age-group” has been discussed, it will be appreciated that various attributes or combinations of attributes may be used to generate fashion-ability scores within the scope of the present disclosure.

In some embodiments, cognitive adjacency planning process 10 may define 202 an association pair of fashion products when each of the fashion products has a fashion-ability score within a pre-defined threshold of each other. In some embodiments, the threshold may be automatically defined (e.g., by cognitive adjacency planning process 10) and/or may be manually defined by a user (e.g., via a user interface). For example, suppose two dresses (e.g., fashion products 424, 428) are available for purchase in a retail space and that fashion product 424 has a fashion-ability score of e.g., 0.74 and that fashion product 428 has a fashion-ability score of e.g., 0.7. Further assume that a predefined threshold of e.g., 0.05 is defined. Because the fashion-ability scores of each fashion product is within the pre-defined threshold from each other, cognitive adjacency planning process 10 may define fashion products 424 and 428 as an association pair. In this manner, because of the fashion-ability scores, these products may be cognitively compatible and may be placed adjacent to one another in the retail space for greater marketability. While an example two dresses has been provided with example fashion-ability scores of e.g., 0.7 and 0.74, it will be appreciated that other fashion products, categories or sub-categories of fashion products, pre-defined thresholds, and fashion-ability scores are possible within the scope of the present disclosure.

In some embodiments, cognitive adjacency planning process 10 may define 202 an association pair of fashion products from different categories. In some embodiments, this may be referred to as a cross-sell. For example, some of the most important aspects of any retail business may be customer engagement and repeat sales. A retail house valuation may be based on customer retention and repeat sales which may be a direct outcome of cross-selling fashion products. As such, cognitive adjacency planning process 10 may define an association pair including fashion products from a different category and/or sub-category. For example, suppose a particular dress (e.g., fashion product 424) has a fashion-ability score of e.g., 0.7 and a scarf (e.g., fashion product 430) has a fashion-ability score of e.g., 0.74, cognitive adjacency planning process 10 may define an association pair with the dress (e.g., fashion product 424) and a scarf (e.g., fashion product 430) with products from a different category and/or sub-category because the fashion-ability scores are within a predefined threshold (e.g., 0.05) of each other. While an example of a dress and a scarf has been provided with example fashion-ability scores of e.g., 0.7 and 0.74, it will be appreciated that other fashion products, categories or sub-categories of fashion products, pre-defined thresholds, and fashion-ability scores are possible within the scope of the present disclosure.

In some implementations, defining 202 a plurality of association pairs from the plurality of products may include determining 510 the visual similarity between each product. In some implementations, determining 510 the visual similarity between each product may include determining cognitive multi-contextual visual similarity via a cognitive computer vision system (e.g., cognitive computer vision system 66). For example, and in some embodiments, cognitive adjacency planning process 10 may convert an image of a product and/or a fashion product into pixel intensities across channels (e.g., RGB), may preform dimension reduction to reduce computational load, and then may apply vector similarity formula like (e.g., Cosine Similarity, Pearson Similarity etc.) on the so obtained vector tensors. This may require IN (e.g. square root of N) complexity (e.g., where N is the number of images) as each image is compared with every other image. In some embodiments, cognitive adjacency planning process 10 may use indexing based approximate similarity algorithms like ANNOY (approximate nearest neighbor) to determine a similarity between one or more products.

In some embodiments, cognitive adjacency planning process 10 may determine a similarity between one or more products by using one or more layers of a neural network (e.g., neural network 702). For example, in deep learning, one way of determining similarity between images of fashion products is to obtain the flattened layer of the image as obtained from the last fully connected layer of a pre-trained neural network. Additional details regarding this process are described, for example, in Sewak, M., Md, Karim, R., & Pujaru, P. (2018). Practical Convolutional Neural Networks. (pp. 103-113). Birmingham, UK: Packt Publishing., which is incorporated herein by reference.

As discussed above and in some implementations, the plurality of products may include a plurality of fashion products. In some embodiments, cognitive adjacency planning process 10 may determine a similarity between one or more fashion products based upon, at least in part, one or more fashion-ability tensors (e.g., fashion-ability tensor 704). In some embodiments, instead of a flattened layer from a neural network as discussed above, cognitive adjacency planning process 10 may use a flattened output of a fashion-ability score and may drive similarities between fashion products from these fashion-ability scores (e.g., fashion-ability score 706) (e.g., using ANNOY or other similarity computation as discussed above). In some embodiments, cognitive adjacency planning process 10 may use one or more fashion-ability tensors (e.g., fashion-ability tensor 704), which may be flattened and used to determine similarity between one or more fashion products.

In some embodiments, cognitive adjacency planning process 10 may define 202 association pairs from the plurality of products for products with similar fashion-ability scores, similar or complimentary colors, and/or similar or complimentary designs from a complementary category or sub-category of fashion products. For example and as discussed above, by utilizing cognitive computer vision systems (e.g., cognitive computer vision system 66), association pairs may be defined 202 for a plurality of visually similar products automatically without user intervention.

In some implementations, cognitive adjacency planning process 10 may determine 204 a plurality of retail locations for the plurality of products based upon, at least in part, the plurality of retail location-based sales data for the plurality of products and the plurality of association pairs defined from the plurality of products. As will be discussed in greater detail below, the placement and adjacency or proximity between products may be optimized in a retail space by determining 204 a plurality of retail locations for the plurality of products based upon, at least in part, the plurality of retail location-based sales data for the plurality of products and the plurality of association pairs defined from the plurality of products. For example and as discussed above, the plurality of association pairs may define relationships between the plurality of products. In some implementations, the association pairs may define products that may usually be purchased together, products that have similar fashion-ability scores, and/or products that are visually similar as defined by a cognitive computer vision system (e.g., cognitive computer vision system 66). From these association pairs, cognitive adjacency planning process 10 may determine 204 a plurality of retail locations for the plurality of products. For example, the plurality of optimized retail locations may include relative positioning of the plurality of products with respect to one another based upon, at least in part, the plurality of retail location-based sales data for the plurality of products and the defined plurality of association pairs from the plurality of products. In this manner, cognitive adjacency planning process 10 may determine optimized retail locations based upon, at least in part, the impact that adjacency or proximity between the plurality of products has on the sale of the plurality of products.

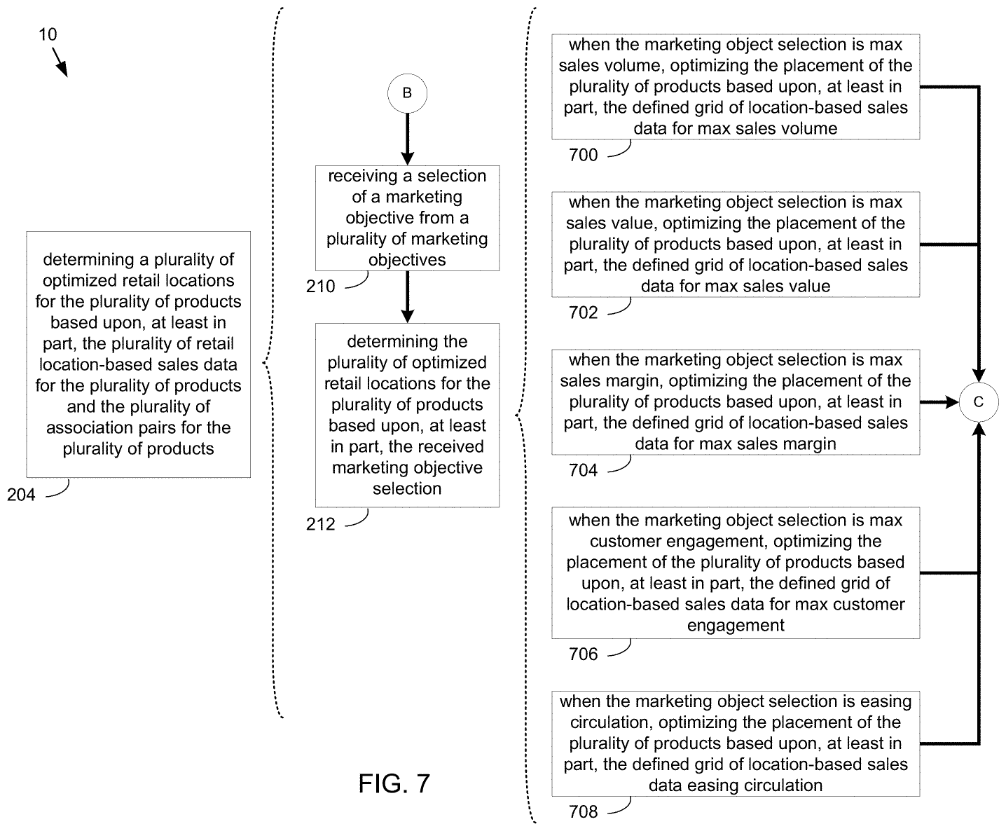

Referring also to FIG. 7 and in some implementations, determining 204 the plurality of retail locations for the plurality of products includes receiving 210 a selection of a marketing objective from a plurality of marketing objectives. A marketing objective may generally include a key performance indicator (KPI) or other business objective or focus for the sale of products in channels of commerce. For example and as discussed above, various marketing objectives may be defined for selection by a user (e.g., user 46 using adjacency planning application 20). Example marketing objectives may include, but are not limited to, maximizing sales volume, maximizing sales value, maximizing sales margin, maximizing customer engagement with products, easing circulation within a retail space, etc. In some implementations, a user (e.g., user 46) of an adjacency planning application (e.g., adjacency planning application 20) may be presented with a user interface from which to select a marketing objective to optimize the placement of the plurality of products with respect to. In some implementations, the user interface may include a plurality of buttons or selectable options representative of the plurality of marketing objectives. For example and in some implementations, cognitive adjacency planning process 10 may determine 212 the plurality of retail locations for the plurality of products based upon, at least in part, the received marketing objective selection. As will be discussed in greater detail below, a plurality of potential or candidate retail locations for a plurality of products in a retail space may be optimized with respect to the selected marketing objective.

In some implementations, determining 212 the plurality of retail locations for the plurality of products based upon, at least in part, the received marketing objective selection may include optimizing 700 the placement of the plurality of products based upon, at least in part, the defined grid of location-based sales data for maximum sales volume when the marketing object selection is maximum sales volume. For example, cognitive adjacency planning process 10 may use the sales volume marketing selection as the optimization function for maximization of the values of the grid of location-based sales data defined with respect to placement of the product on a specific aisle and shelf. As described above and in some implementations, a grid of location-based sales data may be defined for the plurality of products. In some implementations, a grid may be defined for each category and/or sub-category of products and/or fashion products. As this grid includes values representing sales volume for a product as a function of aisle and shelf locations, a plurality of candidate retail locations may be determined based upon, at least in part, the defined grid of location-based sales data. With the received marketing objective selection of maximizing sales volume, cognitive adjacency planning process 10 may determine a plurality of optimized retail locations (e.g., placement on a respective aisle and shelf) from the grid of location-based sales data.

In some implementations, cognitive adjacency planning process 10 may optimize 700 the placement of the plurality of products based upon, at least in part, the defined plurality of association pairs. For example and as discussed above, the adjacency or proximity between products may increase or decrease the likelihood a consumer purchases either product. In the example of fashion products, the plurality of defined association pairs may be based upon, at least in part, the fashion-ability scores generated for the plurality of fashion products. As discussed above, various fashion products may be fashionably compatible with other fashion products based upon, at least in part, the fashion-ability scores defined for the plurality of fashion products. In some implementations, determining 212 the plurality of retail locations for the plurality of products may include optimizing the placement of the plurality of products with the respect to the association pairs.

For example and as discussed above, suppose a dress (e.g., fashion product 424) is associated (e.g., defined in an association pair) with a scarf (e.g., fashion product 430) based upon, at least in part, the fashion-ability scores generated for each fashion product from images of each fashion product. As the placement of the fashion products of this association pair within a pre-defined distance or proximity may increase the sales volume of either fashion product, cognitive adjacency planning process 10 may determine a plurality of optimized retail locations for the dress (e.g., fashion product 424) and the scarf (e.g., fashion product 430) within a retail space that is optimized for sales volume by specifying that each fashion product is positioned within a pre-defined distance or proximity from each other. While an example has been described with a dress and a scarf in an association pair, it will be appreciated that various products in a plurality of association pairs may be used within the scope of the present disclosure.

In some implementations, the plurality of defined association pairs may be based upon, at least in part, the visual similarity of the plurality of fashion products. As discussed above, various fashion products may be visually similar to other fashion products based upon, at least in part, multi-contextual visual similarity defined for the plurality of fashion products. In some implementations, determining 212 the plurality of retail locations for the plurality of products may include optimizing the placement of the plurality of products with the respect to the association pairs.

For example and as discussed above, suppose a first dress (e.g., fashion product 424) is associated (e.g., defined in an association pair) with a second dress (e.g., fashion product 428) based upon, at least in part, the visual similarity of each fashion product based upon images of each fashion product. As the placement of the fashion products of this association pair within a pre-defined distance or proximity may increase the sales volume of either fashion product, cognitive adjacency planning process 10 may determine a plurality of optimized retail locations for the first dress (e.g., fashion product 424) and the second dress (e.g., fashion product 428) within a retail space that is optimized for sales volume by specifying that each fashion product is positioned within a pre-defined distance or proximity from each other.

In some implementations, determining 212 the plurality of retail locations for the plurality of products based upon, at least in part, the received marketing objective selection may include optimizing 702 the placement of the plurality of products based upon, at least in part, the defined grid of location-based sales data for maximum sales value when the marketing object selection is maximum sales value. For example and as discussed above, cognitive adjacency planning process 10 may use the sales value marketing selection as the optimization function for maximization of the values of the grid of location-based sales data defined with respect to placement of the product on a specific aisle and shelf. With the received marketing objective selection of maximizing sales value, cognitive adjacency planning process 10 may determine a plurality of optimized retail locations (e.g., placement on a respective aisle and shelf) from the grid of location-based sales data. As discussed above and in some implementations, cognitive adjacency planning process 10 may optimize 702 the placement of the plurality of products based upon, at least in part, the plurality of defined association pairs (e.g., based upon, at least in part, fashion-ability scores and/or visual similarity) when the marketing object selection is maximum sales value.

In some implementations, determining 212 the plurality of retail locations for the plurality of products based upon, at least in part, the received marketing objective selection may include optimizing 704 the placement of the plurality of products based upon, at least in part, the defined grid of location-based sales data for maximum sales margin when the marketing object selection is maximum sales margin. For example and as discussed above, cognitive adjacency planning process 10 may use the sales margin marketing selection as the optimization function for maximization of the values of the grid of location-based sales data defined with respect to placement of the product on a specific aisle and shelf. With the received marketing objective selection of maximizing sales margin, cognitive adjacency planning process 10 may determine a plurality of optimized retail locations (e.g., placement on a respective aisle and shelf) from the grid of location-based sales data. As discussed above and in some implementations, cognitive adjacency planning process 10 may optimize 704 the placement of the plurality of products based upon, at least in part, the plurality of defined association pairs (e.g., based upon, at least in part, fashion-ability scores and/or visual similarity) when the marketing object selection is maximum sales margin.

In some implementations, determining 212 the plurality of optimized retail locations for the plurality of products based upon, at least in part, the received marketing objective selection may include optimizing 706 the placement of the plurality of products based upon, at least in part, the defined grid of location-based sales data for maximum customer engagement when the marketing object selection is maximum customer engagement. For example and as discussed above, cognitive adjacency planning process 10 may use the maximum customer engagement marketing selection as the optimization function for maximization of the values of the grid of location-based sales data defined with respect to placement of the product on a specific aisle and shelf. With the received marketing objective selection of maximizing sales value, cognitive adjacency planning process 10 may determine a plurality of optimized retail locations (e.g., placement on a respective aisle and shelf) from the grid of location-based sales data. As discussed above and in some implementations, cognitive adjacency planning process 10 may optimize 706 the placement of the plurality of products based upon, at least in part, the plurality of defined association pairs (e.g., based upon, at least in part, fashion-ability scores and/or visual similarity) when the marketing object selection is maximum customer engagement.

In some implementations, determining 212 the plurality of optimized retail locations for the plurality of products based upon, at least in part, the received marketing objective selection may include optimizing 708 the placement of the plurality of products based upon, at least in part, the defined grid of location-based sales data easing circulation when the marketing object selection is easing circulation. For example and as discussed above, cognitive adjacency planning process 10 may use the easing circulation marketing selection as the optimization function for maximization of the values of the grid of location-based sales data defined with respect to placement of the product on a specific aisle and shelf. With the received marketing objective selection of easing circulation, cognitive adjacency planning process 10 may determine a plurality of optimized retail locations (e.g., placement on a respective aisle and shelf) from the grid of location-based sales data. As discussed above and in some implementations, cognitive adjacency planning process 10 may optimize 708 the placement of the plurality of products based upon, at least in part, the plurality of defined association pairs (e.g., based upon, at least in part, fashion-ability scores and/or visual similarity) when the marketing object selection is easing circulation.

In some implementations and given the customer engagement time for each product for different aisles and/or shelves, cognitive adjacency planning process 10 may compute the total customer engagement time for a row as an input for optimization. In some implementations, cognitive adjacency planning process 10 may keep the time per aisle and the ratio between the maximum and minimum aisle time as the optimization function for minimization. In this manner and for this marketing objective of easing circulation, cognitive adjacency planning process 10 may ease the circulation of customers in and through a retail space by optimizing the placement of products that cause consumer congestion in the retail space. For example, certain products may be associated (e.g., as an association pair) with one another because a consumer who interacts with a first product may have a higher likelihood of engaging with a second product. As such and in this example, cognitive adjacency planning process 10 may ease circulation in a retail space by keeping these products apart from each other in the plurality of optimized locations determined for the plurality of products.

In some implementations, cognitive adjacency planning process 10 may generate 206 a planogram on a user interface, the planogram including placement of at least a portion of the plurality of products within a retail space based upon, at least in part, the plurality of retail locations for the plurality of products. For example and in some implementations, cognitive adjacency planning process 10 may generate a new design or a new planogram that may be published and used in the laying out of a retail space. Many conventional planogram design tools focus on replicating the planogram to represent an existing retail space. However, providing a replication of a current retail space layout in the form of a planogram does not include the generating of a planogram on a user interface where the planogram includes placement of at least a portion of the plurality of products within a retail space based upon, at least in part, the plurality of retail locations for the plurality of products. As discussed above, cognitive adjacency planning process 10 may automatically (e.g., without human intervention) and scientifically design or generate a cognitive planogram for a retail space using artificial intelligence and computer vision technologies.

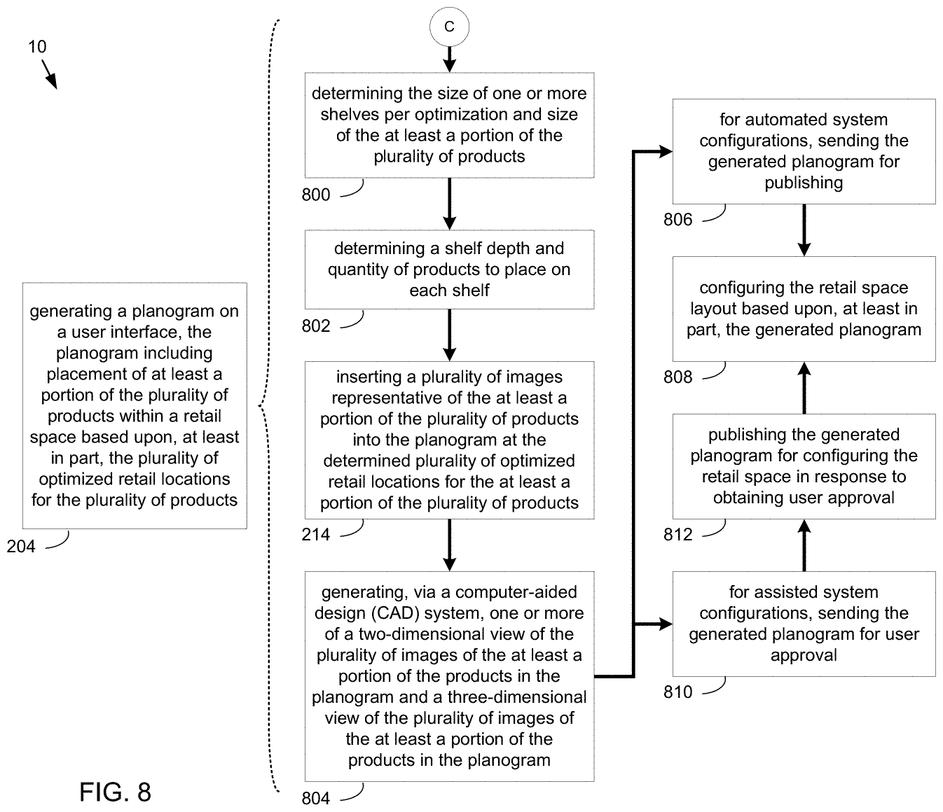

Referring also to FIG. 8 and in response to determining a plurality of retail locations, cognitive adjacency planning process 10 may determine 800 the size of one or more shelves per optimization and size of the at least a portion of the plurality of products. In some implementations, cognitive adjacency planning process 10 may determine 802 a shelf depth and quantity of products to place on each shelf of the planogram. In some implementations, cognitive adjacency planning process 10 may insert 214 a plurality of images representative of the at least a portion of the plurality of products into the planogram at the determined plurality of retail locations for the at least a portion of the plurality of products.

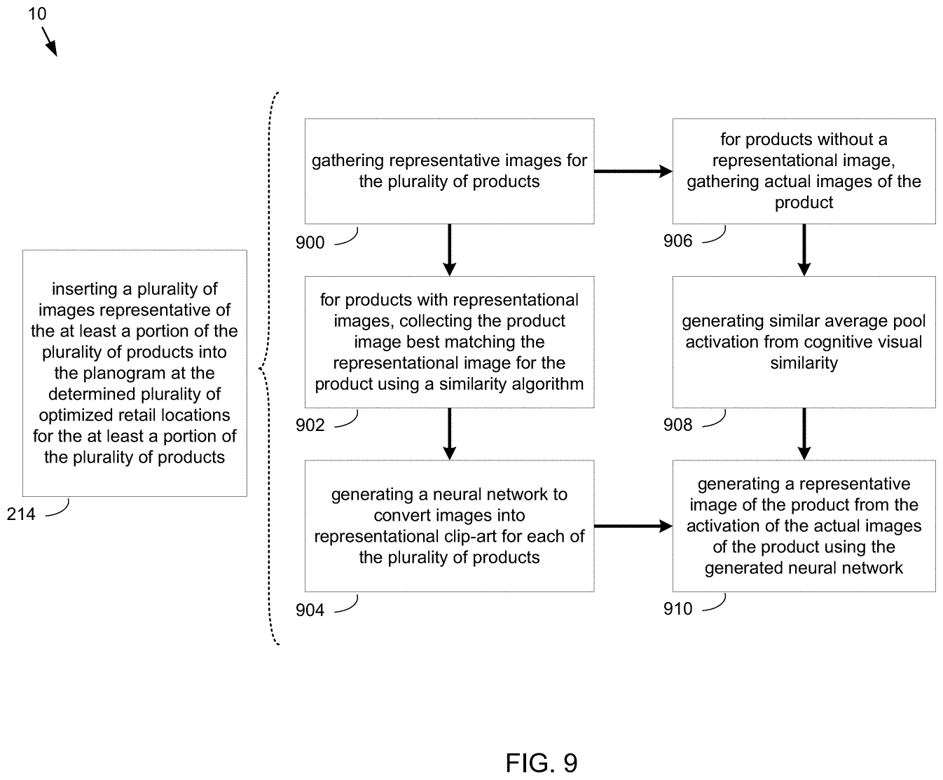

In some implementations and referring also to FIG. 9, inserting 214 the plurality of images representative of the at least a portion of the plurality of products into the planogram at the determined plurality of retail locations for the at least a portion of the plurality of products may include gathering 900 representative images for the plurality of products. In some implementations, cognitive adjacency planning process 10 may collect 902 the product image best matching the representational image for the product using a similarity algorithm for products with representational images. In some implementations, cognitive adjacency planning process 10 may use an average pool activation of all the contexts in the similarity algorithm (e.g., transfer learning) as the input training data to create and train a neural network to convert the best matching images into representational clip-arts. For example, cognitive planning adjacency process 10 may use the average pool activation of all the contexts in the similarity algorithm to create a generative adversarial network (GAN) or other neural network to convert images into representational clips-arts.

In some implementations, where a product does not have a representational image, cognitive adjacency planning process 10 may gather 906 actual images of the product (e.g., from an image database). In some implementations, cognitive adjacency planning process 10 may gather 906 actual images of the product with a single, uniform view of the product. In some implementations, cognitive adjacency planning process 10 may generate 908 a similar average pool activation from cognitive visual similarity (e.g., via multi-contextual visual similarity). In some implementations and with the similar average pool activations, cognitive adjacency planning process 10 may generate 910 a representative image or clip-art of the product from the average pool activation of the actual images of the product using the generated neural network.

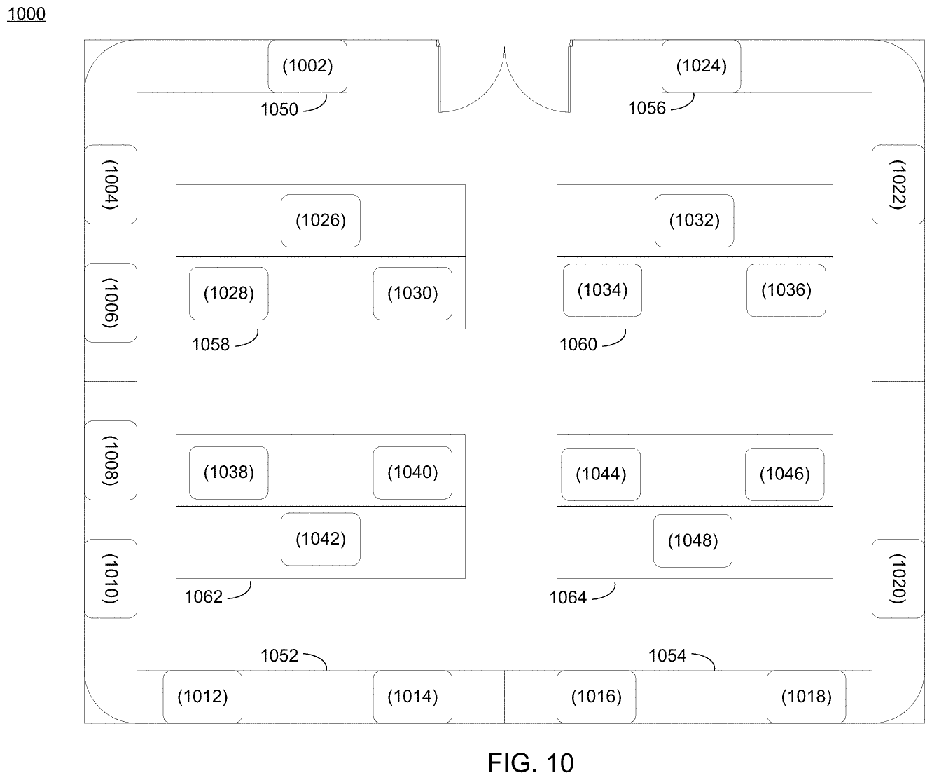

Referring again to FIG. 8, cognitive adjacency planning process 10 may generate 804, via a computer-aided design (CAD) system, one or more of a two-dimensional view of the plurality of images of the at least a portion of the products in the planogram and a three-dimensional view of the plurality of images of the at least a portion of the products in the planogram. Referring also to FIG. 10 and in some implementations, cognitive adjacency planning process 10 may generate 804 a two-dimensional planogram (e.g., planogram 1000), where the planogram includes placement of at least a portion of the plurality of products within a retail space based upon, at least in part, the plurality of retail locations for the plurality of products. In this example, the determined placement of a plurality of products may be represented by a plurality of images of the plurality of products (e.g., product images 1002, 1004, 1006, 1008, 1010, 1012, 1014, 1016, 1018, 1020, 1022, 1024, 1026, 1028, 1030, 1032, 1034, 1036, 1038, 1040, 1042, 1044, 1046, 1048) of the generated planogram (e.g., planogram 1110) placed on a plurality of aisles (e.g., aisles 1050, 1052, 1054, 1056, 1058, 1060, 1062, 1064).

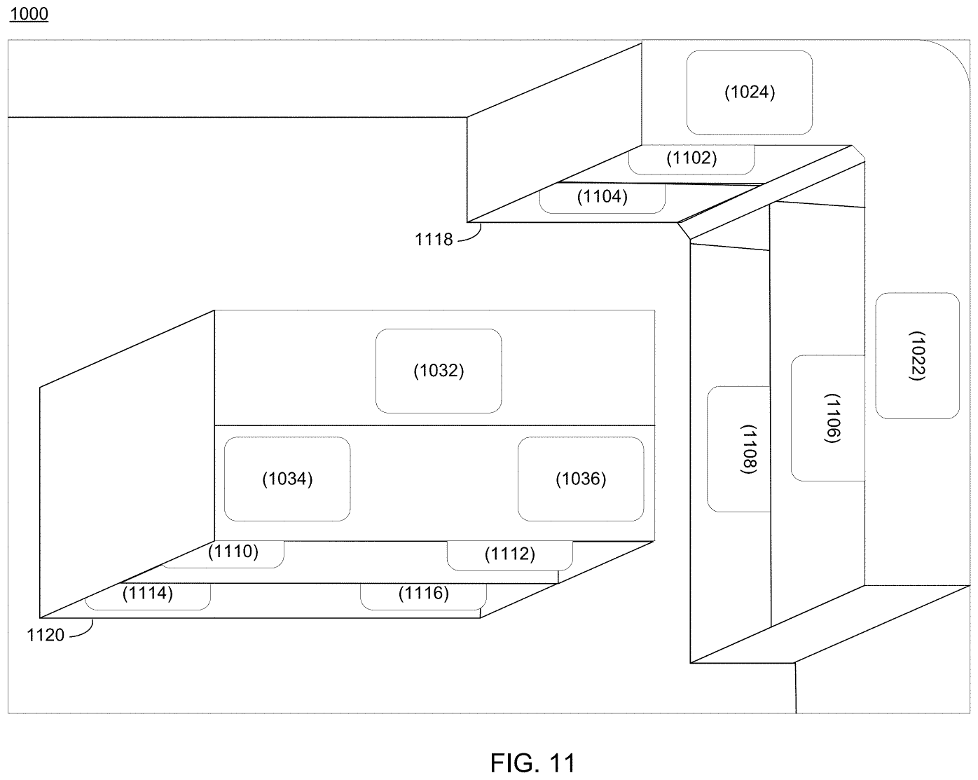

Referring also to FIG. 11 and in some implementations, cognitive adjacency planning process 10 may generate 804 a three-dimensional planogram (e.g., planogram 1000), where the planogram includes placement of at least a portion of the plurality of products within a retail space based upon, at least in part, the plurality of retail locations for the plurality of products. In this example, the determined placement of a plurality of products may be represented by a plurality of images of the plurality of products (e.g., product images 1022, 1024, 1032, 1034, 1036, 1102, 1104, 1106, 1108, 1110, 1112, 1114, 1116) of the generated planogram (e.g., planogram 1000) placed on a plurality of aisles (e.g., aisles 1118, 1120). As shown in FIG. 11, the three-dimensional planogram (e.g., planogram 1000) may include sufficient detail of the plurality of retail locations to show the placement of the at least a portion of the plurality of products in the various shelves and aisles of a retail space. In contrast to the two-dimensional planogram of FIG. 10, cognitive adjacency planning process 10 may include tools or options within the user interface to rotate or reposition a user interface viewing perspective of the retail space to show various portions of the planogram. In this manner, cognitive adjacency planning process 10 may provide a three-dimensional representation of the generated planogram to demonstrate the placement (e.g., aisle and shelf) of the plurality of products within the retail space.

In some implementations and for fully automated system configurations, cognitive adjacency planning process 10 may send 806 the generated planogram for publishing. In some implementations and in response to sending 806 the generated planogram for publishing for automated system configurations, cognitive adjacency planning process 10 may configure 808 the retail space layout based upon, at least in part, the generated planogram. For example, in the case of an automated/robot-assisted retail space layout, cognitive adjacency planning process 10 may configure 808 the retail space based upon, at least in part, the generated planogram. In the case of manual retail space layout configurations, the generated planogram may serve as a blueprint for manually configuring 808 the retail space.

In some implementations and for non-fully-automated adjacency planning systems or configurations, cognitive adjacency planning process 10 may send 810 the generated planogram for user approval. For example, the generated planogram may be sent to e.g., an approver user for approval via an electronic message (e.g., an email with an attachment and/or an inner-adjacency planning application messaging system with an accessible reference to the generated planogram). While an electronic message has been described for providing or sending the generated planogram out for user approval, it will be appreciated that various communication methods and techniques may be used to provide the generated planogram to a user for approval.

In some implementations and in response to receiving a user approval for the generated planogram, cognitive adjacency planning process 10 may configure 808 the retail space layout based upon, at least in part, the generated planogram. As discussed above, in the case of an automated/robot-assisted retail space layout, cognitive adjacency planning process 10 may configure 808 the retail space based upon, at least in part, the generated planogram. In the case of manual retail space layout configurations, the generated planogram may serve as a blueprint for manually configuring 808 the retail space.

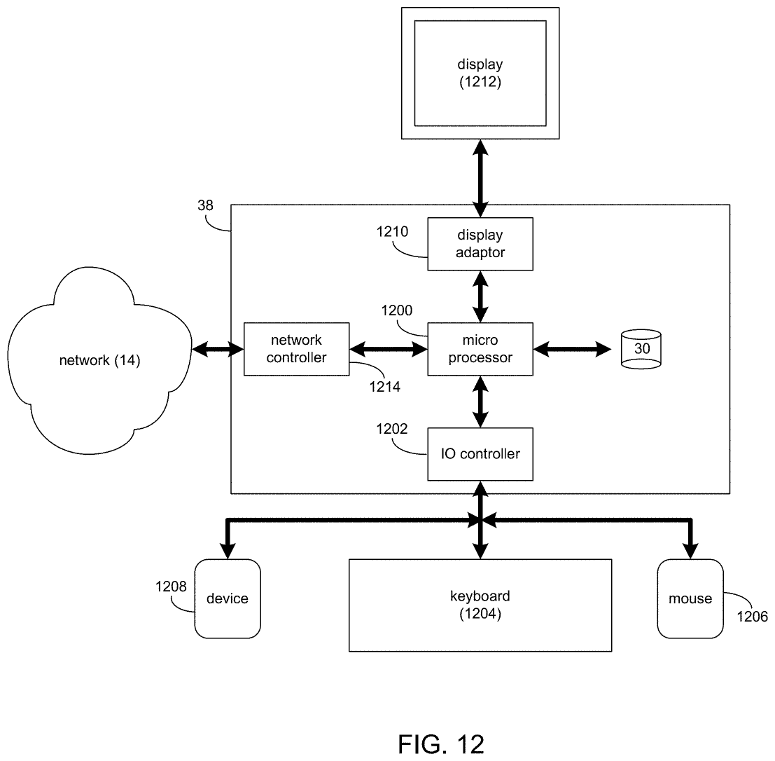

Referring also to FIG. 12, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, cognitive adjacency planning process 10 may be substituted for client electronic device 38 within FIG. 12, examples of which may include but are not limited to computing device 12 and/or client electronic devices 40, 42, 44.

Client electronic device 38 may include a processor and/or microprocessor (e.g., microprocessor 1200) configured to, e.g., process data and execute the above-noted code/instruction sets and subroutines. Microprocessor 1200 may be coupled via a storage adaptor (not shown) to the above-noted storage device(s) (e.g., storage device 30). An I/O controller (e.g., I/O controller 1202) may be configured to couple microprocessor 1200 with various devices, such as keyboard 1204, pointing/selecting device (e.g., mouse 1206), custom device (e.g., device 1208), USB ports (not shown), and printer ports (not shown). A display adaptor (e.g., display adaptor 1210) may be configured to couple display 1212 (e.g., CRT or LCD monitor(s)) with microprocessor 1200, while network controller/adaptor 1214 (e.g., an Ethernet adaptor) may be configured to couple microprocessor 1200 to the above-noted network 14 (e.g., the Internet or a local area network).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
defining, on a computing device, a plurality of location-based sales data for a plurality of products;
defining a plurality of association pairs from the plurality of products;
determining a plurality of retail locations for the plurality of products based upon, at least in part, the plurality of location-based sales data for the plurality of products and the plurality of association pairs defined from the plurality of products; and
generating a planogram on a user interface, the planogram including placement of at least a portion of the plurality of products within a retail space based upon, at least in part, the plurality of retail locations for the plurality of products.

2. The computer-implemented method of claim 1, wherein the plurality of products include a plurality of fashion products and defining the plurality of association pairs from the plurality of fashion products is based upon, at least in part, one or more of a plurality of fashion-ability scores representative of the plurality of fashion products and a visual similarity between the plurality of fashion products.

3. The computer-implemented method of claim 1, wherein defining the plurality of association pairs from the plurality of products includes:
executing, via a machine learning system, one or more sequence mining algorithms on the plurality of retail location-based sales data to define one or more sequential relationships between a subset of the plurality of products purchased during a plurality of transactions.

4. The computer-implemented method of claim 1, wherein determining the plurality of retail locations for the plurality of products includes:
receiving a selection of a marketing objective from a plurality of marketing objectives.

5. The computer-implemented method of claim 4, wherein determining the plurality of retail locations for the plurality of products includes:
determining the plurality of retail locations for the plurality of products based upon, at least in part, the received marketing objective selection.

6. The computer-implemented method of claim 1, wherein the plurality of retail locations for the plurality of products includes relative positioning of the plurality of products with respect to one another based upon, at least in part, the plurality of retail location-based sales data for the plurality of products and the defined plurality of association pairs from the plurality of products.

7. The computer-implemented method of claim 1, wherein generating the planogram on the user interface includes:
inserting a plurality of images representative of the at least a portion of the plurality of products into the planogram at the determined plurality of retail locations for the at least a portion of the plurality of products.

8. A computer program product comprising a non-transitory computer readable storage medium having a plurality of instructions stored thereon, which, when executed by a processor, cause the processor to perform operations comprising:
defining a plurality of location-based sales data for a plurality of products;
defining a plurality of association pairs from the plurality of products;
determining a plurality of retail locations for the plurality of products based upon, at least in part, the plurality of location-based sales data for the plurality of products and the plurality of association pairs defined from the plurality of products; and
generating a planogram on a user interface, the planogram including placement of at least a portion of the plurality of products within a retail space based upon, at least in part, the plurality of retail locations for the plurality of products.

9. The computer program product of claim 8, wherein the plurality of products include a plurality of fashion products and defining the plurality of association pairs from the plurality of fashion products is based upon, at least in part, one or more of a plurality of fashion-ability scores representative of the plurality of fashion products and a visual similarity between the plurality of fashion products.

10. The computer program product of claim 8, wherein defining the plurality of association pairs from the plurality of products includes:
executing, via a machine learning system, one or more sequence mining algorithms on the plurality of retail location-based sales data to define one or more sequential relationships between a subset of the plurality of products purchased during a plurality of transactions.

11. The computer program product of claim 8, wherein determining the plurality of retail locations for the plurality of products includes:
receiving a selection of a marketing objective from a plurality of marketing objectives.

12. The computer program product of claim 11, wherein determining the plurality of retail locations for the plurality of products includes:
determining the plurality of retail locations for the plurality of products based upon, at least in part, the received marketing objective selection.

13. The computer program product of claim 8, wherein the plurality of retail locations for the plurality of products includes relative positioning of the plurality of products with respect to one another based upon, at least in part, the plurality of retail location-based sales data for the plurality of products and the defined plurality of association pairs from the plurality of products.

14. The computer program product of claim 8, wherein generating the planogram on the user interface includes:
inserting a plurality of images representative of the at least a portion of the plurality of products into the planogram at the determined plurality of retail locations for the at least a portion of the plurality of products.

15. A computing system including one or more processors and one or more memories configured to perform operations comprising:
defining a plurality of location-based sales data for a plurality of products;
defining a plurality of association pairs from the plurality of products;
determining a plurality of retail locations for the plurality of products based upon, at least in part, the plurality of location-based sales data for the plurality of products and the plurality of association pairs defined from the plurality of products; and
generating a planogram on a user interface, the planogram including placement of at least a portion of the plurality of products within a retail space based upon, at least in part, the plurality of retail locations for the plurality of products.

16. The computing system of claim 15, wherein the plurality of products include a plurality of fashion products and defining the plurality of association pairs from the plurality of fashion products is based upon, at least in part, one or more of a plurality of fashion-ability scores representative of the plurality of fashion products and a visual similarity between the plurality of fashion products.

17. The computing system of claim 15, wherein defining the plurality of association pairs from the plurality of products includes:
executing, via a machine learning system, one or more sequence mining algorithms on the plurality of retail location-based sales data to define one or more sequential relationships between a subset of the plurality of products purchased during a plurality of transactions.

18. The computing system of claim 15, wherein receiving information associated with the user accessing the first website includes associating one or more fashion products with the user accessing the first website.

19. The computing system of claim 18, wherein determining the plurality of retail locations for the plurality of products includes:
determining the plurality of retail locations for the plurality of products based upon, at least in part, the received marketing objective selection.

20. The computing system of claim 15, wherein the plurality of retail locations for the plurality of products includes relative positioning of the plurality of products with respect to one another based upon, at least in part, the plurality of retail location-based sales data for the plurality of products and the defined plurality of association pairs from the plurality of products.
